(19) United States
(12) Patent Application Publication
(10) Pub. No.: US 2025/0110224 A1
(43) Pub. Date: Apr. 3, 2025

(54) Method for Correcting a Design-Related Aberration of a Lidar Sensor, Computing Device, Lidar Sensor System, Computer Program, and Computer-Readable Storage Medium

(71) Applicant: Bayerische Motoren Werke Aktiengesellschaft, Muenchen (DE)

(72) Inventors: Jonathan FISCHER, Karlsfeld (DE); Nils WALDMANN, Muenchen (DE)

(21) Appl. No.: 18/834,661

(22) PCT Filed: Jan. 9, 2023
(86) PCT No.: PCT/EP2023/050318

§ 371 Date: Jul. 31, 2024

(30) Foreign Application Priority Data
Feb. 1, 2022 (DE) 10 2022 102 322.2

(51) Int. Cl. G01S 7/497; G01S 17/931

(52) U.S. Cl. CPC G01S 7/4972; G01S 17/931

(57) ABSTRACT

A method includes receiving sensor data from a lidar sensor, the sensor data describing the surroundings of a vehicle using a point cloud. The method also includes detecting a characteristic feature in the sensor data, the characteristic feature having a predetermined characteristic. The method also includes detecting the design-related aberration by means of re-verification of the characteristic feature for the predetermined characteristic. The method also includes determining the correction factor, by way of which the design-related aberration in the sensor data can be corrected, such that the detected characteristic feature has the predetermined characteristic during the re-verification in that the characteristic feature and/or the sensor data associated with the characteristic feature is subject to a temporal and/or spatial change contrary to the predetermined characteristic.

### BACKGROUND AND SUMMARY

The present invention relates to a method for determining a correction factor for a correction of a design-related aberration of an automobile lidar sensor during intended operation of the lidar sensor. In addition, the present invention relates to a computing device for a vehicle and a lidar sensor of a vehicle for carrying out such a method. Furthermore, the present invention relates to a lidar sensor system for a vehicle. Finally, the present invention also relates to a computer program product and a computer-readable storage medium.

Lidar sensors are mostly used for surroundings detection in the automotive sector. The term lidar is an abbreviation for the underlying measurement method, which is based on a time-of-flight measurement by way of ultraviolet, infrared, or beams from the range of visible light (“light detection and ranging”). Objects in the surroundings can be detected and the distance therefrom can be measured by way of the optical measurement method.

In time-of-flight measurement, one or more light pulses are emitted and reflected on any object present in the surroundings. The time until the reflected signal is received is proportional to the distance in this case. The emission directions, i.e., for example, the azimuth angle and elevation angle of the emitted light pulses, enable exact localizing of the reflection point and thus of the object in the surroundings. However, a high level of angle accuracy is necessary in this case.

For reasons of design technology, it is often desirable for lidar sensors to be installed behind a cover on the vehicle. Such covers are already known from radar sensors and are often referred to as radomes. In the field of lidar sensors, such covers are also referred to as lidomes or design covers. However, such a design cover can also result in an angle distortion of the emitted and/or the received light pulses—in particular due to external environmental influences. Overall, it can thus result in a distortion of the lidar point cloud, i.e. the set of all reflection points. Therefore, it is possible that objects in the surroundings are incorrectly localized and/or that detected objects or their dimensions are incorrectly determined. Since presently design covers are not used for lidar sensors in the automotive sector, there are also presently no known methods for correcting a distortion due to a design cover (often also called methods for rectification).

To equip a lidar sensor with a large field of view, it can be advantageous if the lidar sensor is based on multiple lidar subsensors. This can be useful in particular if emitting and/or receiving elements of the lidar sensor are based on micro electromechanical mirrors (MEMS mirrors). A field of view of the lidar sensor of, for example, 100°, 150°, and in particular of more than 180° can usually be implemented only using multiple lidar subsensors. The field of view of the lidar sensor is composed of the smaller fields of view of the respective lidar subsensors. For example, a field of view of 180° can be implemented from two lidar subsensors having a field of view of 95° each, in which case the fields of view of the two lidar subsensors overlap here in a range of 5°.

If lidar subsensors are used, exact calibration of the lidar subsensors in relation to one another has to be ensured in particular. If the lidar subsensors are not exactly calibrated in relation to one another, for example, in the case of a slight vertical offset, the object size (for example of a further road user) can possibly be incorrectly determined in the vertical direction in the overlap range of the vertically offset fields of view of the lidar subsensors. The offset or the design-related aberration also has to be established and corrected in such a case—in the best cases during the intended operation. No methods are also presently known for this purpose.

Further design-related aberrations can occur, for example, due to mechanical wear. It is thus conceivable that individual lenses, mirrors, or the like have certain deficits over time. These can be caused, on the one hand, by mechanical force action and, on the other hand, by aging-related wear. No methods for correcting such a distortion are presently known for this purpose either.

In summary, no methods for correcting a design-related aberration of an automobile lidar sensor during intended operation, i.e. in particular during operation of the vehicle in conventional road traffic, are known to date.

Document DE 10 2016 225 595 A1 describes a method and an arrangement for calibrating at least one sensor of a rail vehicle. To calibrate at least one sensor of a rail vehicle, a reference object is detected in the surroundings, from which features are extracted, on the basis of which a processor calibrates the sensor. The calibration of the sensor is carried out during a journey of the rail vehicle. The method is based on the use of surroundings invariants—i.e. features which were present from the outset in the vehicle surroundings or were installed especially for the method—for online calibration of one or more sensors of the rail vehicle. The calibration is carried out progressively or at intervals during the journey in a regular line operation of the rail vehicle in this case. The regular repetition of the calibration during the journey offers the advantage that the sensor system can react directly to dynamic changes in the rail vehicle, in that calibration data from existing surroundings structures are collected and processed permanently during operation. This enables more frequent and accurate calibration, which increases the level of safety and enables novel applications. As a result, maintenance intensity and costs for the sensor system are also reduced.

Published international application WO 2021/197709 A1 relates to a method for recognizing a decalibration of a lidar sensor of a vehicle. A reference measurement is carried out by way of the lidar sensor here, in which, by emitting laser radiation in at least one predetermined scanning plane, at least one line is projected on a roadway surface, and in which a location of the at least one line relative to the vehicle is determined. At a later point in time, a verification measurement is carried out, in which, likewise by emitting laser radiation in the at least one predetermined scanning plane, at least one line is projected on the roadway surface, and in which a location of the at least one line relative to the vehicle is determined. The determined locations are compared to one another. If the comparison shows that the locations determined in the reference measurement and verification measurement have shifted in relation to one another by more than a predetermined amount, degradation of the lidar sensor is concluded. The radiation reflected back can also be detected by way of a photodetector arranged outside the lidar sensor, for example by way of a camera which has a sensor chip sensitive to the wavelength of the laser radiation, typically IR radiation. The reference measurement and verification measurement are preferably carried out while the vehicle is at a standstill. For example, the reference measurement is carried out upon parking of the vehicle and the verification measurement is carried out upon the subsequent starting of the vehicle. It can therefore be established whether an event which has resulted in the decalibration of the sensor has taken place during the parking.

Document EP 2 199 828 A2 describes a method for determining the relative location of a laser scanner, which acquires a 2D profile of its surroundings in a scanning plane and is carried along by a vehicle in a direction of travel external to the scanning plane in order to create a 3D depiction of the surroundings, relative to a reference system of the vehicle, comprising the following steps: using a laser scanner, the scanning plane of which is pre-selectable in at least two angular positions, creating the area at two different angular positions of the laser scanner, and determining the relative location from a comparison of the spatial location of an object in the first 3D image to the spatial location of the same object in the second 3D image.

It is the object of the present invention to disclose a solution by which a design-related aberration of an automobile lidar sensor can be recognized and corrected during intended operation of the lidar sensor.

This object is achieved according to the claimed invention.

A method according to embodiments of the invention for determining a correction factor for a correction of a design-related aberration of an automobile lidar sensor during intended operation of the lidar sensor comprises continuously receiving sensor data from the lidar sensor, wherein the sensor data describe the surroundings of a vehicle by way of a point cloud. Moreover, the method comprises detecting a characteristic feature in the sensor data, wherein the characteristic feature has a predetermined characteristic at a first point in time. The method also comprises detecting the design-related aberration by way of a renewed check of the characteristic feature for the predetermined characteristic at a second point in time. Finally, the method comprises determining the correction factor, with the aid of which the design-related aberration is correctable in the sensor data, such that the detected characteristic feature, while it is detected in the sensor data corrected using the correction factor, has the predetermined characteristic in the context of the renewed check. In this case, the design-related aberration is detected in the context of the renewed check in that the characteristic feature and/or the sensor data associated with the characteristic feature are subject to a chronological and/or spatial change contrary to the predetermined characteristic.

In other words, a correction of a design-related aberration is to be enabled by way of the method according to embodiments of the invention, i.e. during the intended operation of the lidar sensor. A design-related aberration can be caused, for example, by a design cover. In the production of a lidar sensor, a so-called fundamental calibration without design cover is typically carried out. A subsequent basic correction of the calibration with design cover permits adaptation to the design cover of the lidar sensor. Finally, an additional correction of the calibration with design cover can be carried out in the vehicle. It is thus ensured that the lidar sensor has a high level of angular accuracy upon delivery of the vehicle. The angle of the light pulse and thus each reflection point can thus be calibrated with high accuracy. An accuracy of 0.025° or better can thus be ensured, for example.

It is now possible using the method according to embodiments of the invention for determining a correction factor for a correction of a design-related aberration to react to individual aberrations during the operation of the lidar sensor. For example, design-related aberrations can occur due to a deformation of the design cover. A deformation of the design cover can occur, for example, due to a travel speed of the vehicle and an accompanying wind load, which acts on the design cover. It is also possible that a deformation of the design cover occurs due to component stresses as a result of temperature variations.

It is also possible that in the case of a lidar sensor, the field of view of which is composed of the fields of view of multiple lidar subsensors, a design-related aberration is present due to a decalibration of the lidar subsensors in relation to one another. Such a decalibration and the accompanying design-related aberration can occur, for example, due to road unevenness, collisions, and/or other mechanical force actions.

In order to initially establish that a design-related aberration is present in the lidar sensor, a characteristic feature can be detected in the sensor data. In other words, a characteristic feature can be extracted from the point cloud of the lidar sensor. The characteristic feature is not necessarily bound here to a predetermined (physical) object. Instead, the characteristic feature can be individual portions of an object, but also an arrangement of multiple objects in relation to one another. The characteristic feature can be determined here depending on a predetermined characteristic. A predetermined characteristic can be, for example, a particular geometric arrangement of reflection points. For example, it is conceivable that a minimum number of reflection points along a straight line is used as the predetermined characteristic. Reflection points along a straight line can occur, for example, due to a guard rail, a lane marking, and/or the like.

Sensor data can be received from the lidar sensor progressively or continuously here. What is essential in particular is comparison of the sensor data or the comparison of a characteristic feature and its properties (the predetermined characteristic) at two different points in time. Initially, the characteristic feature including the predetermined characteristic can be detected, for example, at the first point in time, wherein the first point in time is chronologically before the second point in time. Subsequently (or at the second point in time) it can be checked whether and how the characteristic feature and its properties (i.e. the predetermined characteristic) change.

The characteristic feature can be chronologically and/or spatially tracked for this purpose. The design-related aberration can thus be detected in that, in the context of a renewed check at a later point in time (at the second point in time), it is checked whether the characteristic feature still has the predetermined characteristic-which the characteristic feature possessed at the first point in time. If this is no longer the case, i.e. the sensor data associated with the characteristic feature no longer have the predetermined characteristic, a design-related aberration may be present. However, it is essential for this purpose that the characteristic feature and its property (the predetermined characteristic) have a certain chronological and/or spatial consistency. Additionally or alternatively, it is also possible that a change in the characteristic feature and its property (the predetermined characteristic) can be predicted on the basis of further assumptions and/or items of information.

The correction factor can also be determined in that the sensor data at the second point in time are corrected such that the sensor data associated with the characteristic feature at the second point in time have the predetermined characteristic again. It is thus possible to react to a design-related aberration during the intended operation of the lidar sensor. As a result, a high level of angle accuracy of the lidar sensor can be progressively ensured, even if this sensor is installed behind a design cover in/on the vehicle. The correction factor can be individual values which act on individual points of the lidar point cloud or on the respective individual lidar beams. The correction factor can also be a correction mask or the like, which can accordingly be used for the overall correction of the lidar point cloud or the corresponding lidar data.

The correction factor can also be determined so that in the context of the method according to embodiments of the invention, a new emission direction of individual light pulses as a result of the design-related aberration is inferred. For example, it may be that a light pulse is emitted at an angle of 5° by the lidar sensor (for example as a result of a 5° alignment of a MEMS mirror), but the angle is actually 6° due to a deformation of the design cover. In other words, in this example, the new emission direction of 6° of the light pulse as a result of the design-related aberration can be inferred by way of the method according to embodiments of the invention. The new emission direction can thus be taken into consideration in the context of signal processing by way of the correction factor. However, it is also possible to change the individual light pulse or the alignment of the corresponding MEMS mirror so that the emission direction is again 5° in the subsequent measurements/scans—in spite of the deformation of the design cover.

In addition, it is advantageous if the characteristic feature in the point cloud of the sensor data from the lidar sensor describes an infrastructure feature and the predetermined characteristic comprises at least one minimum dimension of the infrastructure feature. Infrastructure features mean elements in the surroundings of the vehicle which are not objects in the sense of the object recognition by the lidar sensor.

The object recognition of the lidar sensor or a computing unit connected to the lidar sensor can be used to recognize objects in the point cloud of the sensor data. The objects can be, for example, further road users—i.e. passenger vehicles, trucks, motorcycles, pedestrians, and/or the like—as well as traffic signs or the like. The recognized objects are often described by way of bounding boxes in the context of the object recognition. In other words, the dimensions of the recognized objects are among the parameters determined in the context of the object recognition. Moreover, the object can be classified in the context of the object recognition.

It should be emphasized that the concept of the object as used in this document essentially refers to objects in the sense of the object recognition by the lidar sensor. It is often the case that object recognition by the lidar sensor encompasses, for example, solely predefined objects—i.e., for example, further road users, traffic signs, traffic signal systems, etc.; therefore, the term “infrastructure feature” should be considered in particular to mean those (physical) objects which are not detected, described, and/or classified in the context of object recognition. These are thus in particular, for example, curbs, roadway markings, sections of houses and buildings, etc.

An infrastructure feature can thus include, for example, roadway markings, guard rails, roadway boundaries, parts of buildings, or the like. For example, the characteristic feature can thus also represent a gutter of a building—and thus an infrastructure feature. In this example, a gutter forms a long straight line, the reflection points of which—if light pulses are reflected on the gutter of the building—have similar reflection properties. In this example, a minimum length or minimum dimension of the straight line or the gutter can be used as the predetermined characteristic.

If the infrastructure feature, i.e. the gutter, now moves due to the intrinsic movement of the vehicle or the lidar sensor through the field of view of the lidar sensor, a deformed design cover can cause compression, stretching, an offset, and/or curvature of the characteristic feature or the gutter to occur in the sensor data from the lidar sensor in a specific area of the field of view. Such compression, stretching, offset, or curvature can thus cause a chronological and/or spatial change in the characteristic feature. However, since the characteristic feature or the infrastructure feature described by the characteristic feature is should have chronologically and/or spatially consistent dimensions, a design-related aberration can be inferred.

It is also conceivable in this case that, by way of a method for simultaneous localization and mapping (SLAM), a comparison is carried out between the lidar point cloud and a surroundings map. The characteristic feature can be extracted from the sensor data and subsequently compared to the map data. In principle, this procedure can also be applied in reverse—thus beginning with the extraction of a characteristic feature in the map data and subsequent comparison in the sensor data. If a SLAM method is used for recognizing and correcting a design-related aberration, it is also conceivable that the design-related aberration can be established at a single point in time. The renewed check of the characteristic feature for the predetermined characteristic can thus take place at a second point in time which is identical to the first point in time.

In general, it should be taken into consideration in this case that chronologically and/or spatially consistent dimensions should be regarded as the absolute values of the feature. For example, it is conceivable that due to the movement of the lidar sensor relative to the characteristic feature, an imaging dimension of the characteristic feature in the sensor data changes, although the actual dimension of the object does not change. To conclude the design-related aberration—as already mentioned above—a chronological and/or spatial change can be predicted or an intrinsic movement of the lidar sensor can be compensated for on the basis of further assumptions and/or items of information.

Therefore, it is possible to determine a correction factor which causes a correction or rectification of the sensor data or the point cloud, so that the characteristic feature has the predetermined characteristic in the context of a renewed check in the sensor data at the second point in time that have been corrected using the correction factor. However—in particular in the case of a mechanical correction of the emission direction of individual light pulses (for example as described above by way of a realignment of individual MEMS mirrors)—it can also be provided that the characteristic feature fulfills the predetermined characteristic only at a third point in time chronologically following the second point in time.

However, it can also be advantageous if the characteristic feature describes a specific geometric parameter of an object recognized in the point cloud of the sensor data from the lidar sensor. For example, a width of the object, a length of the object, a specific contour of the object, or the like can be used as the characteristic feature. If the object is tracked over time and the object performs a relative movement within the field of view of the lidar sensor in this case, it may be the case that the specific geometric parameter of the recognized object changes. It is thus possible that, for example, the width of a truck changes. Such a change can arise due to a changing distance from the truck or also due to a deformation of the design cover of the lidar sensor. If the width of the truck changes independently of the distance from the truck, for example, the design-related aberration can thus be inferred.

It is advantageous in this case if additional image data are received from a camera which describe the surroundings of the vehicle and by way of which the recognized object is verified. In other words, the additional image data are thus used to confirm the object recognized in the point cloud of the sensor data from the lidar sensor. Robustness of the detection of the design-related aberration can be increased by a confirmation of the recognized object. It is thus possible to prevent, for example, any object detected as a false positive by the lidar sensor from being used to detect the characteristic feature.

An advantageous (alternative) embodiment provides that additional image data are received from a camera, wherein the additional image data describe an object in the surroundings of the vehicle by way of an object area, and the characteristic feature is detected in the sensor data associated with the object area. It is thus also possible that initially an object is detected in the image data, then described by an object area, and then the characteristic feature is extracted from this object area or is extracted from the sensor data associated with the object area.

The use of the camera has the advantage that characteristic features can be detected more reliably. If a truck is recognized in the image data, for example, and it is known that a truck has a long straight edge, which is possibly predestined as the characteristic feature, it is thus possible to search directly for the characteristic feature in the sensor data associated with the object area. It can thus also be implicitly ensured that the characteristic feature has the predetermined characteristic (for example a long straight edge or a rectangular dimension).

As already stated, it can be particularly advantageous if the characteristic feature is describable by a straight visual object edge in the image data. Such a straight visual object edge can originate, for example, from a truck, a roadway marking, a roadway edge, a curb, a guard rail, and/or the like. The visual object edge can be extracted from the image data, for example, by way of an algorithm for edge detection. A characteristic feature which is represented by a linear arrangement of the reflection points in the point cloud of the lidar sensor is particularly advantageous in order to recognize design-related aberrations. Recognition of compressions, stretches, and/or other distortions due to the design-related aberration—i.e., for example, a deformation of the design cover and/or the offset in the case of multiple lidar sensors—is thus particularly easily recognizable.

In general, it is also advantageous if the characteristic feature is describable by multiple reflection points of the point cloud arranged along a straight line and the reflection points arranged along the straight line have similar reflection properties. Typically, the reflection properties of an individual reflection point and thus of the object can be inferred as a function of the reflected power of a light pulse. Similar reflection properties have the advantage here that improved detection of the characteristic feature is possible in this way.

For example, if there are significantly different reflection properties of a characteristic feature, under certain circumstances, it cannot be ensured that this is a feature which is chronologically and/or spatially consistent and is therefore accordingly suitable for detecting the design-related aberration. In other words, if there are significantly varying reflection properties, under certain circumstances, it cannot be ensured that the predetermined characteristic remains constant in a certain manner. As already mentioned, the arrangement of the reflection points along a straight line serves for especially easy recognizability of the design-related aberration, i.e., for example, the deformation of the design cover of the lidar sensor or offset in the case of multiple lidar subsensors.

A further advantageous embodiment provides that system status data are received which describe an operating status of the vehicle, wherein the operating status comprises at least one driving status of the vehicle and/or an external surroundings status, and the correction factor is only determined when the system status data describe an operating status to be corrected. In general, it is possible to carry out the determination of the correction factor for correcting the design-related aberration permanently or at certain predefined time intervals. However, it can also be advantageous if the determination of the correction factor or the correction of the design-related aberration takes place depending on predefined operating statuses.

An operating status upon which a determination of the correction factor or a correction of the design-related aberration may be necessary can be defined, for example, as a function of the current driving speed or the current driving status, which may comprise the current driving speed. For example, it is possible that the lidar sensor and thus the design cover of the lidar sensor is subjected to an increased wind load depending on the current driving speed. Such a wind load can exert a force on the design cover of the lidar sensor and therefore can result in a deformation of the design cover and thus in a design-related aberration. The system status data can describe such an operating status to be corrected-thus, for example, due to the increased wind load. It is therefore possible to carry out the determination of the correction factor or the correction of the design-related aberration precisely when an operating status to be corrected is described by the system status data.

Further possible operating statuses to be corrected can also be present, for example, due to external surroundings statuses. Increased solar radiation on the design cover and/or an increased ambient temperature can also result in a deformation of the design cover and thus in a design-related aberration. A shock of greater or lesser severity can also result, in the case of multiple lidar subsensors, in an offset in the individual point clouds of the lidar subsensors or a decalibration and thus a design-related aberration. Such shocks can be detected, for example, by way of an acceleration sensor and accordingly can also be incorporated in the system status data. If the determination of the correction factor or the correction of the design-related aberration is carried out as a function of the system status data, energy and computing power can be saved.

Finally, it is also advantageous if the chronological and/or spatial change in the characteristic feature and/or the sensor data associated with the characteristic feature is characterized by a stretching, compression, and/or curvature.

A further aspect of the invention relates to a computing device for a vehicle which is configured to carry out a method according to embodiments of the invention. The computing device can have at least one processor and/or one memory. The computing device can be formed by at least one electronic control unit.

A lidar sensor system according to embodiments of the invention for a vehicle comprises a lidar sensor, which in turn comprises multiple lidar subsensors and/or a design cover. In addition, the lidar sensor system comprises a computing device according to embodiments of the invention for a vehicle, which is configured to carry out a method according to embodiments of the invention.

A vehicle according to embodiments of the invention comprises a lidar sensor system according to embodiments of the invention. The vehicle can be designed in particular as a passenger vehicle.

Furthermore, the invention relates to a computer program comprising commands which, upon execution of the program by a computing device, cause it to carry out a method according to embodiments of the invention. Finally, the invention relates to a computer-readable storage medium, comprising commands which, upon execution by a computing device, cause it to carry out a method according to embodiments of the invention.

The preferred embodiments presented with reference to the method and the advantages thereof apply accordingly to the computing device according to the invention, to the lidar sensor system according to embodiments of the invention, to the vehicle according to embodiments of the invention, to the computer program according to embodiments of the invention, and to the computer-readable storage medium according to embodiments of the invention.

Further features of the invention will be apparent from the claims, the figures, and the description of the figures. The features and combinations of features mentioned above in the description and the features and combinations of features mentioned hereinafter in the description of the figures and/or solely shown in the figures are usable not only in the respective specified combination but also in other combinations or alone without departing from the scope of the invention.

The invention will be explained in more detail on the basis of preferred exemplary embodiments and with reference to the appended drawings.

### BRIEF DESCRIPTION OF THE DRAWINGS

FIG. 1 shows a flow chart of various calibration or correction steps of a lidar sensor.

FIG. 2 shows a representation of various exemplary embodiments of a method for determining a correction factor of a lidar sensor in the form of a flow chart.

FIG. 3 shows a schematic representation of a design-related aberration due to a deformed design cover of a lidar sensor.

FIG. 4 shows a representation of sensor data from a lidar sensor which comprises two decalibrated lidar subsensors and which as a result has a design-related aberration.

### DETAILED DESCRIPTION OF THE DRAWINGS

In the figures, identical or functionally identical elements are given identical reference signs.

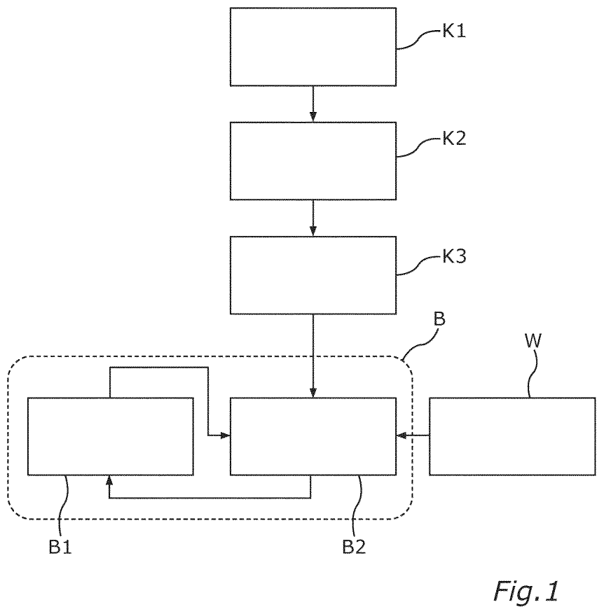

FIG. 1 shows a flow chart of various calibration or correction steps of a lidar sensor 1. Initially a fundamental calibration K1 of the lidar sensor 1 is carried out without design cover 2. Such a fundamental calibration K1 can be carried out without taking into consideration the dynamics of the vehicle. For example, the fundamental calibration K1 of the lidar sensor 1 can take place during the production of the lidar sensor 1. Subsequently, a so-called base correction K2 of the fundamental calibration K1 can take place as soon as the lidar sensor 1 is installed for the first time behind the design cover 2. This step can also take place in the context of the production of the lidar sensor 1 and usually does not comprise dynamics of the vehicle. Finally, an additional correction K3 of the base correction K2 can take place when the lidar sensor 1, together with design cover 2, has been installed in the vehicle. The additional correction K3 can take place during the production of the vehicle. The dynamics of the vehicle or external environmental influences can also be ignored in this case.

The method according to embodiments of the invention for determining a correction factor for a correction of a design-related aberration 10 of a lidar sensor 1 offers the possibility of carrying out a correction of the additional correction K3 during intended operation B, i.e. in particular while the vehicle is in road traffic. During the intended operation B of the lidar sensor 1, various events (see step B1) which result in a design-related aberration 10 can occur.

Independently of the type of the events, a design-related aberration 10 can occur. Therefore, monitoring and fine correction of the additional correction K3 are carried out continuously in step B2. If the design-related aberration 10 is not correctable, a visit to the repair shop is necessary under certain circumstances in step W.

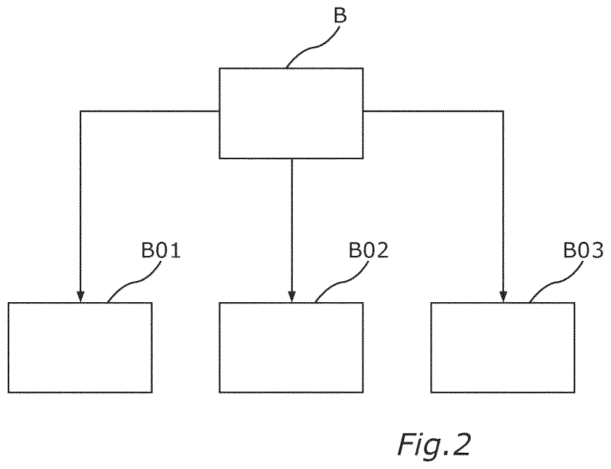

FIG. 2 shows a representation of various exemplary embodiments of a method for determining the correction factor of the lidar sensor 1 in the form of a flow chart. During intended operation B, there may be a change, for example, in the driving status of the vehicle, i.e., for example, the driving speed and as a result the wind load which acts on the design cover 2. It is also conceivable that an ambient temperature will change. Furthermore, a mechanical force may also act on the design cover 2 and/or a mount of the lidar sensor 1.

During intended operation B of the lidar sensor 1 or in the context of the monitoring and fine correction (cf. step B2), a characteristic feature can now initially be detected in the continuously received sensor data. In principle, three variants are conceivable in this case: by way of roadway markings or infrastructure features (see step B01), by way of a specific geometric parameter of a recognized object (for example the dimensions of a truck, see step B02), or by way of a camera comparison (see step B03).

In step B01, i.e., for example, by way of roadway markings, lane markings are initially recognized by the lidar sensor 1. The recognized roadway markings can now initially be interpolated. Subsequently, possibly with the aid of additional items of information about the driving status (driving speed, yaw rate, steering angle, and/or the like), a comparison of the recognized and interpolated roadway markings to perfect parallel lines can be carried out. In case of a variance, this can be corrected, for example, by way of lateral stretching and/or compression so that the roadway markings extend in parallel.

In step B02, i.e., for example, when prior knowledge about dimensions of a truck is used, for example, a truck is initially recognized and tracked (typically during the relative approach and moving away). The distance-dependent (possibly angle-dependent) contour of the truck can subsequently be compared to a target contour. A stretching and/or compression factor for the correction of the contour can be determined.

Analogous examples in which prior knowledge about dimensions can be used comprise traffic signs, direction sign gantries, or traffic sign gantries. In general, targets of good suitability are in particular those which have good detectability due to high reflectivity and have a straight structure or shape.

In step B03, a camera comparison of the sensor data from the lidar sensor 1 can be carried out. Initially, objects are recognized by a camera and the lidar sensor for this purpose. A stretching and/or compression factor can then be determined, so that maximum correspondence of the camera with the lidar sensor 1 is achieved.

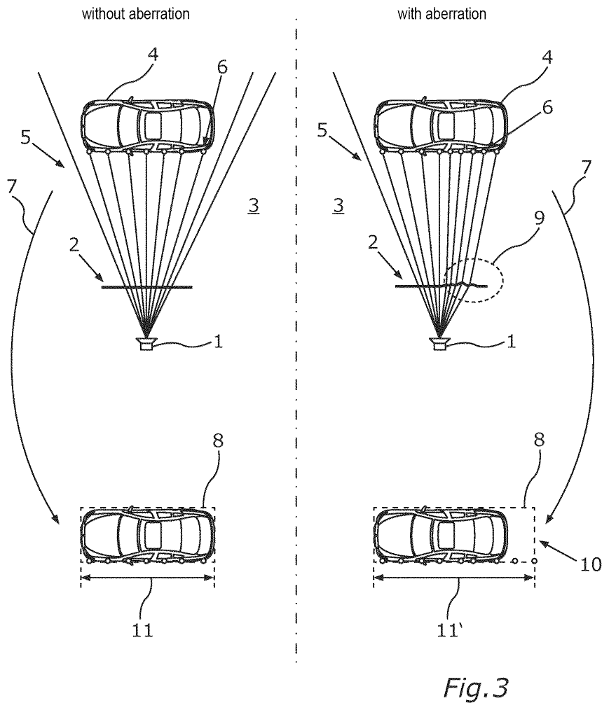

FIG. 3 shows a schematic representation of a design-related aberration 10 due to a deformed design cover 2 of a lidar sensor 1. First, an error-free detection of the surroundings 3 by way of the lidar sensor 1 is shown on the left side. A passenger vehicle 4, which is scanned with the aid of multiple light pulses 5, is located in the surroundings 3. The reflection points 6—i.e. the points which reflect the light pulses 5 back—are used for the object recognition of the lidar sensor 1 and are part of the point cloud of the lidar sensor 1.

The object recognition or the object formation is represented by the arrow 7. The detected object can be described, for example, by way of an enveloping cuboid/rectangle 8. If the lidar sensor 1 is correctly calibrated as a result of the calibration or correction steps K1, K2, and K3, error-free detection of the surroundings 3 is possible. The error-free detection of the surroundings 3 can be seen on the left side of FIG. 3 in particular due to the highly accurate description of the passenger vehicle 6 by way of the enveloping cuboid/rectangle 8.

The same situation (cf. left side) is shown again on the right side of FIG. 3, wherein due to a deformed design cover 2, a design-related aberration 10 and, as a result, an erroneous detection of the surroundings 3 is shown. The design cover 2 is deformed in the area 9. Such a deformation can occur, for example, due to mechanical stresses, an increased wind load as a result of a high driving speed, temperature variations, and/or the like.

The deformation in the area 9 can now have the result that individual light pulses 5 of the lidar sensor 1 are deflected or distorted. In particular, azimuth angle and/or elevation angle of the lidar sensor 1 can be distorted. As a result—as shown on the right side of FIG. 3—more light pulses 5 can be reflected from the passenger vehicle 4, for example, than in the situation on the left side of FIG. 3. Therefore, those light pulses 5 which are actually supposed to be sent past the passenger vehicle 4 can hit the passenger vehicle 4. As a result, a design-related aberration 10 can occur. In the context of object recognition or object imaging, which is shown by the arrow 7, the dimensions of the passenger vehicle 4 can be incorrectly determined. An excessively large enveloping cuboid/rectangle 8 shows that the dimensions of the passenger vehicle 4 were incorrectly determined on the right side of FIG. 3.

The design-related aberration 10 can now be recognized in the scope of the method according to embodiments of the invention for determining a correction factor for a correction of the design-related aberration 10 of the automobile lidar sensor 1 during intended operation B of the lidar sensor 1 in that the passenger vehicle 4 is used as the characteristic feature and a predetermined vehicle length 11 is used as the predetermined characteristic.

If the characteristic feature—thus the passenger vehicle 4—is now detected at a first point in time (shown on the left side of FIG. 3) and then tracked, it can be checked again at a later point in time (the second point in time, shown on the right side of FIG. 3) whether the characteristic feature still has the predetermined characteristic—i.e. the predetermined vehicle length 11.

Since the passenger vehicle 4 has the vehicle length 11′ on the right side of FIG. 3—thus at the second point in time-a design-related aberration 10 can now be inferred. The sensor data at the second point in time can as a result be corrected so that the design-related aberration 10—i.e. the angle error due to the deformation of the design cover 2 in the area 9—is compensated for.

However, it is also possible to change the (future) emission direction of those light pulses 5 in such a way (for example by way of a realignment of individual MEMS mirrors of the lidar sensor 1) that the emission direction of the light pulses after emerging from the (deformed) design cover 2 corresponds to the originally intended emission direction and therefore the characteristic feature only fulfills the predetermined characteristic again at a third point in time (not shown in FIG. 3) chronologically following the second point in time.

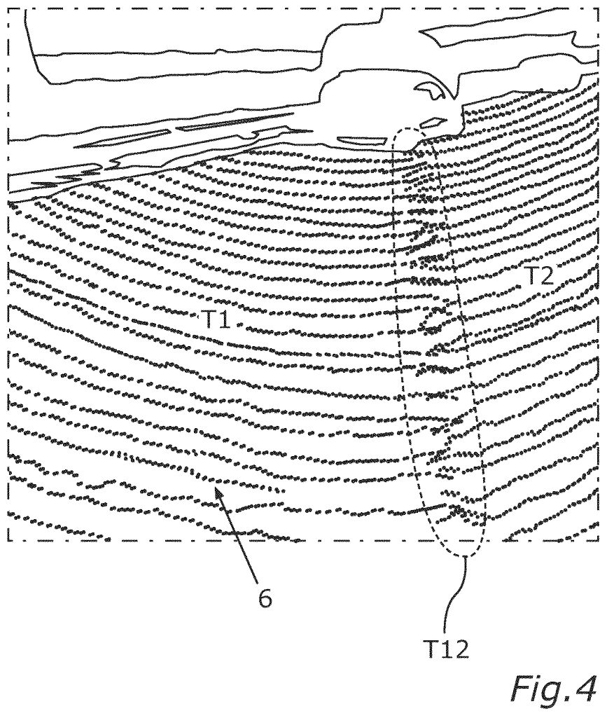

FIG. 4 shows a representation of sensor data from a lidar sensor 1, which comprises two decalibrated lidar subsensors and which as a result has a design-related aberration 10. The first lidar subsensor has a field-of-view T1. The second lidar subsensor has a field-of-view T2. The field-of-view of the lidar sensor 1 has a field-of-view which comprises the field of view T1 and T2. The fields of view T1 and T2 overlap here in an overlap area T12.

If the two lidar subsensors are not exactly calibrated in relation to one another, for example, a slight vertical offset (as is visible in FIG. 4) of the reflection points 6 can occur in the overlap area T12. As a result, under certain circumstances, the object size (for example of a further road user) in the vertical direction can be incorrectly determined.

1.-13. (canceled)

14. A method for determining a correction factor for a correction of a design-related aberration of an automobile lidar sensor during intended operation of the lidar sensor, the method comprising:
continuously receiving sensor data from the lidar sensor, wherein the sensor data describe surroundings of a vehicle by way of a point cloud,
detecting a characteristic feature in the sensor data, wherein the characteristic feature has a predetermined characteristic at a first point in time,
detecting the design-related aberration by way of a renewed check of the characteristic feature for the predetermined characteristic at a second point in time, and
determining the correction factor, with aid of which the design-related aberration in the sensor data is correctable such that the characteristic feature, when detected in the sensor data corrected using the correction factor, has the predetermined characteristic in context of the renewed check,
wherein the design-related aberration is detected in the context of the renewed check in that the characteristic feature and/or the sensor data associated with the characteristic feature are subject to a chronological and/or a spatial change contrary to the predetermined characteristic.

15. The method according to claim 14, wherein:
the characteristic feature in the point cloud of the sensor data from the lidar sensor describes an infrastructure feature and the predetermined characteristic comprises at least one minimum dimension of the infrastructure feature.

16. The method according to claim 14, wherein:
the characteristic feature describes a specific geometric parameter of an object recognized in the point cloud of the sensor data from the lidar sensor.

17. The method according to claim 16, wherein:
additional image data are received from a camera, which image data describe the surroundings of the vehicle and by way of which image data the recognized object is verified.

18. The method according to claim 14, wherein:
additional image data are received from a camera, wherein the additional image data describe an object in the surroundings of the vehicle by way of an object area and the characteristic feature is detected in the sensor data associated with the object area.

19. The method according to claim 17, wherein:
the characteristic feature is describable by a straight visual object edge in the image data.

20. The method according to claim 18, wherein:
the characteristic feature is describable by a straight visual object edge in the image data.

21. The method according to claim 14, wherein:
the characteristic feature is describable by multiple reflection points of the point cloud arranged along a straight line and the reflection points arranged along the straight line have similar reflection properties.

22. The method according to claim 14, wherein:
system status data are received, which system status data describe an operating status of the vehicle, the operating status comprises at least one driving status of the vehicle and/or an external surroundings status, and the determination of the correction factor only takes place when the system status data describe an operating status to be corrected.

23. The method according to claim 14, wherein:
the chronological and/or the spatial change in the characteristic feature and/or the sensor data associated with the characteristic feature is characterized by a stretching, a compression, and/or a curvature.

24. A computing device for a vehicle, wherein the computing device is configured to carry out the method according to claim 14.

25. A lidar sensor system for a vehicle, the lidar sensor system comprising:
a lidar sensor, which comprises multiple lidar subsensors and/or a design cover, and
the computing device for the vehicle according to claim 24.

26. A computer product comprising a non-transitory computer-readable medium having stored thereon program code, which when executed on a computing device, carries out the method according to claim 14.
